(19) United States
(12) Patent Application Publication
(10) Pub. No.: US 2003/0119441 A1
(43) Pub. Date: Jun. 26, 2003

(54) Messaging arrangement

(75) Inventors: Paul R. Simons, Redhill (GB); Saul R. Dooley, Reigate (GB)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V.

(21) Appl. No.: 10/323,446

(22) Filed: Dec. 19, 2002

(30) Foreign Application Priority Data
Dec. 22, 2001 (GB) 0130812.1

(51) Int. Cl. H04H 1/00

(52) U.S. Cl. 455/3.01; 455/39; 455/73

(57) ABSTRACT

A mobile terminal receives ‘push-type’ message broadcasts that carry header information indicating the content of the message. Three hierarchical message category designators each consist of a 16 bit word where only one bit may be set to designate each of 16 categories. The first word indicates the message category at a first hierarchical level, the second word the message category at a second hierarchical that falls within the category designated at the first hierarchical level. Similarly the third word designates a category at a third hierarchical level that falls within the category designated at the second hierarchical level. A user specifies those received message categories that are of interest by profile words and at each hierarchical level a bit-for-bit correlation is performed by correlators respectively. If a match is established at each hierarchical level the complete received message is processed by the device, otherwise it is ignored in order to conserve device resources and reduce power consumption.

The present invention relates to a method of communicating information to receiving equipment and a system and apparatus for enabling the transmission and reception of such information.

In an environment where information is being broadcast according to a particular scheme for reception by suitably enabled receiving equipment, in particular portable receiving equipment, only certain types of the broadcast information will be of interest to a user. A need exists to allow received information of interest to the user to be processed accordingly but to reject information quickly and efficiently if it is not of interest. In one envisaged model, information is broadcast by providers of services or goods for reception by receiving equipment of a user to alert the user of the availability of information, services or items of interest. While it is in the interest of the parties behind the broadcasts to target the information to people who are likely to be most interested in the availability of a particular type of service or goods, this is not always possible by general known means, such as user profiling. User profiling may not be possible because data relating to a particular user may not be known and privacy considerations often result in potential recipients choosing not to make personal information available.

An approach to avoiding the above mentioned problems is to determine whether any received broadcast information is of interest to a user or useful to receiving apparatus at the receiving side of the arrangement, and to process the received information appropriately, such as alerting the user of its presence, only if the information is deemed to be of interest. A way of determining whether received information will be of interest to a user or useful to the mobile terminal is to perform the process of identifying the content of the message that is being received and to check whether a user has already specified to the receiving equipment at an earlier time whether information messages carrying such content are of interest. It is possible to analyse the whole message content to determine whether the message is likely to be of interest but such an approach can require appreciable processing to be performed that can consume valuable device resources and take an unacceptable amount of time.

It is possible to include information in the broadcast message itself to indicate that the message is of a type belonging to a particular category. One example of message identification is known from the ‘Specification of the radio data system (RDS)’ as described in European Standard EN 50067 (English language version: December 1990) at pages 15 to 18. Radio broadcasts employing such message identification include information following a predefined format in which codes are used to identify to receivers the type of information being broadcast, for example basic tuning and switching information, radiotext, and clock time and date. There is no mention of the possibility of implementing user defined settings at the receiver to dictate how such received information should be used.

It is an object of the present invention to provide a method and apparatus which allows for the determination of whether particular received information is of interest.

In accordance with an aspect of the present invention there is provided a method of performing information transmissions from a transmitting station for reception by a receiving station, said method including the step of:

providing in at least one of said transmissions classification data formatted to comprise at least two portions each serving to indicate a classification of the associated information transmission content, wherein one of the at least two portions serves to indicate the classification at a first hierarchical level and another one of the at least two portions serves to indicate the classification at a second hierarchical level, the classification indicated at the second hierarchical level being a sub-classification of the classification indicated at the first hierarchical level.

Therefore it is possible to examine the classification data of received information transmissions to determine the classification of the received associated information transmission content, without the need for examining the associated information transmission content itself. Such an approach is potentially much quicker than that of examining the associated information transmission content itself as it can require less processing effort and even be performed in a fast hardware arrangement. If a received information transmission message carries classification data which indicates at the first hierarchical level a classification that does not match a classification at the same hierarchical level previously specified by a user of their equipment to be a classification of interest, the message may be rejected or largely ignored. Such an approach avoids alerting the user to information previously specified as being of no interest. This approach also allows the users equipment to stop processing the message any further therefore conserving resources such as processing capability, memory and reducing power demands. Indeed, parts of the users equipment may adopt a power saving mode.

If the received information transmission message is deemed to carry classification data which indicates at the first hierarchical level a classification that does match a classification at the same hierarchical level previously specified by a user of their equipment to be a classification of interest, the received information transmission message is examined to determine whether the classification data indicates at the second hierarchical level a classification that also matches a classification at the same hierarchical level previously specified by a user of their equipment to be a classification of interest. It is noted that such a second hierarchical level indicates classifications that belong to a sub-category of that category indicated at the first hierarchical level. If a received information transmission message carries classification data which indicates at the second hierarchical level a classification that does not match a classification at the same hierarchical level previously specified by a user of their equipment to be a classification of interest, the message may be rejected or largely ignored. If, on the other hand the received information transmission message is deemed to carry classification data which indicates at the first and second hierarchical level a classification that does match a classification at the same first and second hierarchical level previously specified by a user of their equipment to be a classification of interest, the receiving equipment may further process the received information transmission, in particular to process the associated information transmission content appropriately, which may involve alerting the user to the content or carrying out some other function. The further processing may be optional in the event that the classification data comprises more than two portions, with each further portion corresponding to a further classification hierarchical level. Classification data including such further hierarchical classification levels is utilised in a similar way to the first and second hierarchical level information, that is, to determine whether classifications match those specified by a user of being of interest. Each further classification hierarchical level may indicate a category that is a sub-category of a category indicated at another superior classification hierarchical level.

The method may further comprise the step of including in at least one of said transmissions a supplemental data indication denoted by a content field designator.

The method may further comprise the step of including in at least one of said transmissions a content detail identifier portion. Such a portion may be arranged to convey data formatted in Extendible Mark-up Language (XML), or other mark-up or description languages such as HTML or WML.

Optionally, at least one classification data portion comprises a word having a given number of bits and only one bit of that word may be set to a value different to the other bits of that word at a particular time. This approach allows for a simple processing arrangement, such as a one-bit hardware correlator, to determine the classification indicated by the word. Furthermore, by adopting -an arrangement where only one bit at a time may be set to indicate the classification designated by the word, it is not possible to set all bits simultaneously, which would otherwise imply that the message falls into all possible categories that could be indicated by a word at that hierarchy. Thus, it is not possible to target all recipients irrespective of the categories a recipient has specified as being of interest merely by providing information transmissions with classification data that indicates that the message belongs to all possible categories.

These and other aspects and optional features of the present invention appear in the appended claims to which the reader is now referred and which are incorporated herein by reference.

The present invention will now be described with reference to the Figures of the accompanying drawings wherein:

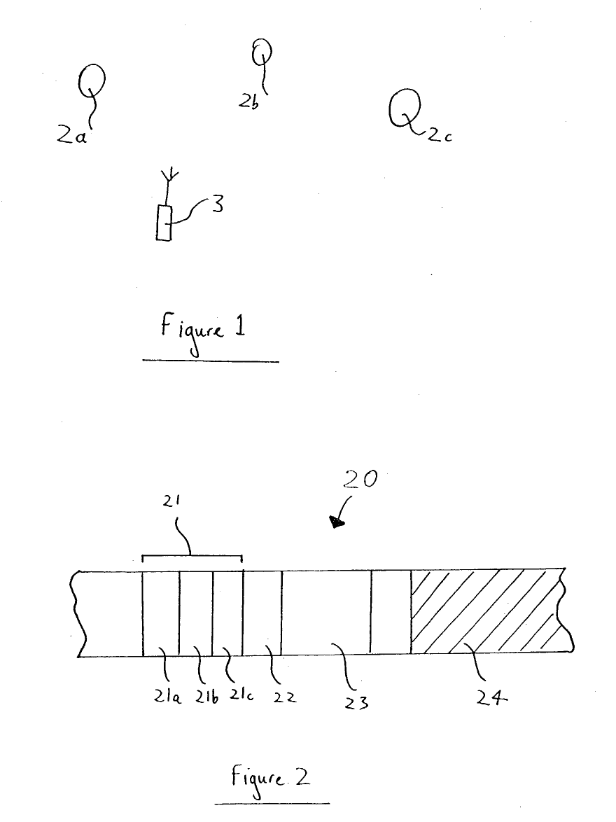

FIG. 1 shows a system for communication of information employing the present invention;

FIG. 2 shows part of an example information broadcast formatted in accordance with the present invention;

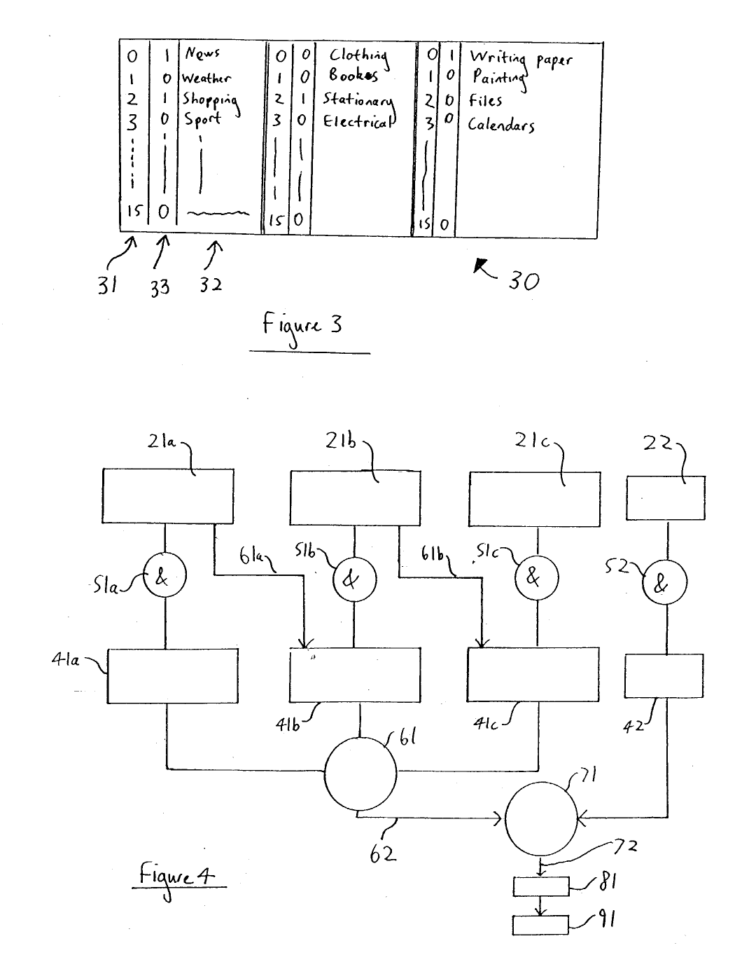

FIG. 3 shows a portion of one data category set suitable for use in the present invention; and

FIG. 4 is a schematic representation of the steps involved in processing received information broadcasts made in accordance with the present invention.

It should be noted that the drawings are diagrammatic and not drawn to scale. Relative dimensions and proportions of parts of the Figures have been shown exaggerated or reduced in size for the sake of clarity and convenience in the drawings. The same reference signs are generally used to refer to corresponding or similar features in the different embodiments.

In contemplation of the advent of low cost broadcast beacons, shopping centres and other busy areas will become a noisy environment for mobile terminals. By providing a protocol that will effectively filter large quantities of broadcast content to ensure that a user is only alerted to relevant information, battery power and processing resources may also be conserved. In one arrangement the protocol requires that each broadcast signal includes a content description that is used to determine if the content is of interest to receiving equipment, the content description comprising two parts; a category description for course filtering followed by a content detail description for a finer level of filtering. Typically the category description is a short binary code to indicate the content of the broadcast signal. This is designed to allow the initial stage of category filtering to be conducted in hardware (although a hardware implementation is not essential). If the category description matches with a users category profile, a second filtering stage is used to process and determine the content detail.

The beacons will broadcast information in the form of so called ‘push’ services for which there will be a need to enable a receiving device to determine very quickly if the broadcast message content requires further attention or be generally ignored.

An information broadcast system 1 employing the present invention comprises one or more transmitters in the form of transmitting beacons 2a, 2b, 2c . . . . 2n each intended for periodically transmitting at least one message. Hereinafter the beacons 2a, 2b, 2c . . . 2n will be referred to collectively as beacons 2 unless the context requires otherwise. Typically the messages transmitted depend on the location and ownership of the beacon. In the case of a beacon located at a shop entrance the beacon may transmit information relating to services or goods offered by the shop, in particular any special offers. In the case of a shopping centre, more than one beacon each distributed strategically within the shopping centre may broadcast information relating to services or goods offered by a particular shop in order to reach a larger number of potential recipients. A beacon may perform transmissions for more than one shop, stepping through the respective transmissions in sequence. Beacons may be strategically placed in airports, railway stations, at bus stops, cafes or even in vehicles. Indeed, the information broadcast could be that of any party willing to pay the owners of the beacons or supporting infrastructure. Potential recipients could even subscribe to a service that provides information to their interest such as football results or the weather forecast, and at any time the recipient is in reception range of one of the beacons transmitting such information, users equipment receives and processes the messages received.

Receiving apparatus 3 is typically, although not essentially, mobile in nature so that it may be carried by a user. In the present example the receiving apparatus is provided in the form of a portable telephone handset although the apparatus could be provided in any other suitable device such as a personal digital assistant (PDA) or other wearable computing apparatus. The transmissions made by the beacons are intended for reception over a range that depends on the system implementation. In the present example the beacons operate according to the so-called Bluetooth radio transmission system and so radio communication distances from a transmitting beacon to receiving apparatus are typically in the order of a few metres to a few tens of metres.

It will be apparent that not all members of the public have the same interests or needs and so the prospect of a user receiving transmissions and being alerted as to the content of all those transmissions irrespective of their subject matter has the potential to overload a user with information. In areas where beacons are prolific leading to the reception of many messages of which a reasonable proportion are of no interest to a user, the user will be tempted to disable the message reception facility which will reduce the effectiveness of this form of information delivery. Another undesirable result of all transmissions being received and processed by a handset will be the consumption of device resources such as processing time and storage capacity together with unnecessary power consumption which is highly unfavourable in the case of a portable device having an exhaustible power supply.

Therefore each pushed message has a header appended to the front to identify the message as belonging to a particular category in terms of message subject matter. An example of a portion of a received message 20 is shown in FIG. 2 where the message includes a broad message category identifier in the form of hierarchical message category identifier 21 comprising three parts 21a, 21b, 21c each in the form of a 16 bit word. The first word 21a is set to designate the category of the associated information transmission content, the second word 21b is set to designate the sub-category of the associated information transmission content, where the sub-category is one belonging to the category designated by the first word 21a, and the third word 21c is set to designate in more detail the category of the associated information transmission content, the third word 21c designating a sub-category belonging to the sub-category designated by second word 21b. For each word, only one bit may be set differently to the other bits of that word. The message also includes a message content field designator 22 which is also in the form of a 16 bit word. Finally, the header also includes a message content detail identifier portion 23 which in the present example is a text file in the form of an appropriate hierarchical language, for example Extendible Mark-up Language (XML) although other representations of the content detail are possible, whether or not in the form of a description language, as will be apparent to the person skilled in the art.

The receiving apparatus utilises the received message identifier information to determine whether the message is of interest by matching the received category words to a users interest, based on a profile set by the user. The profile includes a category profile specifying category identifiers of interest for matching with received category identifier words 21a, 21b, 21c. The profile also includes a content field profile specifying message content field data of interest for matching with received content field designator 22, and a detail profile specifying data of interest that may appear in the message content detail identifier portion 23.

The first 16 bit word 21a is used to designate the category of the message at a first hierarchical level. Since only one bit position may be set to the value of ‘1’ at a given time, the word may designate one of 16 different categories, depending on which bit position is set. With reference to FIG. 3, a look-up table 30 shows the correspondence between bit position and category. Each bit position listed in column 31 corresponds to a predetermined subject listed in column 32 such as ‘News, Weather, Shopping and Sport’. In the present example let us assume that the received message has category identifier first word 21a with its bit position 2 set to a value of ‘1’ to indicate that at a first hierarchical level the message falls into the category of ‘Shopping’.

In the present example let us also assume that the user has set their profile to specify that messages received in the general category of ‘shopping’ are of interest. This is done by setting the users category profile, which also contains a look-up table the same as that shown in FIG. 3, to specify at the first hierarchical level that all received first words 21a having bit position 2 set to a value of ‘1’ indicate that the message received is likely to be of interest. The preferred user profile settings are shown in column 33 and the interest in receiving messages relating to ‘shopping’ is shown by setting first hierarchical level user profile bit position 2 to a value of ‘1’. It is noted that the user profile may specify more than one category to be of interest at a particular hierarchical level and in the example shown the user profile contains bit positions ‘0’ and ‘2’ set to a value of ‘1’ to indicate that the categories ‘News’ and ‘Shopping’ are of interest.

FIG. 4 illustrates one process of determining whether a received message is of likely interest to a user by reference to a user profile. A hardware correlator is used, although a similar process could be implemented in software. On reception of a message 20, received first category word 21a is compared to stored category profile first word 41a in a bit wise AND operation 51a to determine whether the received message category matches with a stored profile category of interest at a first hierarchical level. If a match is found, the received first category word 21a is used to select a stored category profile second word representing sub-categories of the category indicated by the first category word 21a. This is shown at 61a. Next, received second category word 21b is compared to the selected stored category profile second word 41b in a bitwise AND operation 51b to determine whether the received message category matches with the selected stored profile category of interest 41b at the second hierarchical level. If a match is found, the received second category word 21b is used to select a stored category profile third word representing a category that is a sub-category of that indicated by the second category word 21b. This is shown at step 61b. Next, received third category word 21c is compared to the selected stored category profile third word 41c in a bitwise AND operation 51c to determine whether the received message category matches the selected stored profile category of interest 41c at the third hierarchical level.

If a match between a received category word 21a, 21b, 21c and the respective stored category profile words 41a, 41b, 41c is established, this is communicated to an input of 3-input AND gate 61. In the case of a match being established at all three hierarchical levels, an enabling signal appears at the output 62 of AND gate 61 which serves as a first input to OR gate 71. When such an enabling signal is input to OR gate 71, it appears at output 72 of OR gate 71 to enable processing of the received message content detail carried in identifier portion 23 at stage 81. In the case the content detail 23 is provided in XML language, an XML parser may be employed. The received message content detail provides a comprehensive listing of message content, which may be used by a receiving device to finally determine whether to process the associated information transmission content 24 itself. If a match is not established at a particular hierarchical level, matches for subsequent hierarchical levels are not attempted and stored category profile words for subsequent hierarchical matching are not selected. Termination of such processing offers the possibility of conserving device resources and reducing power consumption.

In certain instances, a received message may contain supplemental information of interest even if the category words 21a, 21b, 21c do not indicate this to be the case. An example of this would be a message advertising a product falling outside the scope of a users category profile, but which message also carries beacon (therefore the nearby receiving device) location information. The presence of such supplemental information is indicated by information carried in the content field designator word 22. This is also a 16 bit word, with each bit position signifying that the associated information transmission content 24 itself carries a particular type of information or that the particular type of information appears in the content detail 23. For example, if content field designator word 22 has its third bit position set to a value of ‘1’ this is an indication that the message carries location information. Content field word 22 may have more than one bit position set to a value of ‘1’, each bit position indicating that the message carries a certain type of information. Content field word 22 is compared to a stored content field profile word 42 (set to indicate information a user is interested in receiving) in a bitwise AND operation indicated by 52, also using a hardware correlator. In the case of a match being established, this is communicated to a second input of the OR gate 71 to enable processing of the received message content detail 23 at stage 81. As already mentioned, the content detail of identifier portion 23 can be provided in the XML language in which case an XML parser may be employed. The supplemental information, the presence of which is indicated by content field word 22 (in this case location information) may be carried in the received message content detail 23 or the associated message content 24 itself.

In the event that an enabling signal does not appear at the output of OR gate 71, the content detail 23 is not processed, therefore conserving device resources and reducing power consumption. In the event that the processing of content detail 23 reveals that the received message is not of interest, the decision may be taken not to process the content 24 itself, therefore conserving device resources and reducing power consumption.

Otherwise, where the enabling signal does appear at the output of OR gate 71, the content detail 23 may be processed. If the analysis of the content detail 23 at step 81 shows the message to be of interest, the information transmission content 24 itself may be processed.

Other modifications and optional features may be provided in the case of the present invention without departing from the scope of the present invention, as will be apparent to the person skilled in the art. For example, the number of words used to represent a category profile may be altered as may the number of bits in each word. While the embodiment described allows 1 bit of a given word to be set to a value of 1 giving each word a maximum of 16 different values, the overall value of each word may be used to represent the category at a particular hierarchical level. In the case of a 16 bit word, 4096 values may be represented by that word.

Different versions of category content field and content detail look-up table may be used and systems provided with facilities to update and synchronise versions of look-up table used by message broadcasters and message receiving equipment. Different versions of look-up tables may be used to provide messaging in different languages.

Existing Bluetooth baseband chips already have correlators for correlating against access codes. Such hardware could be adapted to perform correlation of category and content information broadcast, with minimal effort.

The described arrangement is suitable for use as a filtering agent for a variety of broadcast content. It may be applied to a variety of infrastructures that deliver content. Typical examples include radio protocols such as GSM, UMTS, Bluetooth, 108.11, terrestrial and satellite TV, infrared IRDA and other such implementations. While the present invention is described with respect to information transmissions and reception of such transmissions, the present invention may be implemented over communications networks such as the Internet, where transmissions are performed by a server, and receptions are handled by a client or other terminal.

In the above description, reference is made to transmissions being made as ‘broadcasts’. The term may be construed as meaning the transmission of information for reception by one or more device, irrespective of whether or not those devices are known to the broadcasting device.

From reading the present disclosure, other modifications will be apparent to persons skilled in the art. Such modifications may involve other features which are already known in the design, manufacture and use of apparatus and methods for information transmission or reception, the coding and formatting used prior to and during such transmission or reception, and applications thereof, which may be used instead of or in addition to features already described herein.

1. A method of performing information transmissions from a transmitting station for reception by a receiving station, said method including the step of:
providing in at least one of said transmissions classification data formatted to comprise at least two portions each serving to indicate a classification of the associated information transmission content, wherein one of the at least two portions serves to indicate the classification at a first hierarchical level and another one of the at least two portions serves to indicated the classification at a second hierarchical level, the classification indicated at the second hierarchical level being a sub-classification of the classification indicated at the first hierarchical level.

2. A method according to claim 1 wherein said at least two portions comprise three portions:
the first portion serving to indicate the classification at a first hierarchical level,
the second portion serving to indicate the classification at a second hierarchical level which is below that of the first hierarchical level, the classification indicated being a sub-classification of that classification indicated at the first hierarchical level; and
the third portion serving to indicate the classification at a third hierarchical level which is below that of the second hierarchical level, the classification indicated being a sub-classification of that classification indicated at the second hierarchical level.

3. A method in accordance with claim 1 wherein each classification data portion comprises a word having a given number of bits and only one bit of each word may be set to a value different to the other bits of that word at a particular time.

4. A method according to claim 1 and further comprising the step of including in at least one of said transmissions a supplemental data indicator carried in a content field designator.

5. A method according to claim 1 and further comprising the step of including in at least one of said transmissions a content detail identifier portion.

6. A method according to claim 5 wherein the content detail identifier portion conveys data formatted in the form of Extendible Markup Language (XML) to indicate the content of the associated information transmission.

7. A method of processing received information transmissions transmitted from a transmitting station, the transmissions being of a type where there is provided in at least one of said transmissions classification data formatted to comprise at least two portions each serving to indicate a classification of the associated information transmission content, wherein one of the at least two portions serves to indicate the classification at a first hierarchical level and another one of the at least two portions serves to indicated the classification at a second hierarchical level, the classification indicated at the second hierarchical level being a sub-classification of the classification indicated at the first hierarchical level, said method comprising the steps of:
analysing said classification data to determine whether the one of the at least two portions that serves to indicate a classification at the first hierarchical level indicates a classification that corresponds to a classification previously deemed to be of interest, and
in the event said first hierarchical level classification does so correspond;
analysing said classification data to determine whether the another one of the at least two portions serves to indicate a classification at the second hierarchical level that corresponds to a classification previously deemed to be of interest; and
optionally further processing said received information message content in the event said first and second level hierarchical level classifications correspond to those classifications deemed to be of interest by a user.

8. A system employing the method of claim 1.

9. A system employing the method of claim 7.

10. Apparatus for formatting information for transmission by a transmitter station performing information transmissions, said apparatus including:
formatting means for providing in at least one of said transmissions classification data formatted to comprise at least two portions each serving to indicate a classification of the associated information transmission content, wherein one of the at least two portions serves to indicate the classification at a first hierarchical level and another one of the at least two portions serves to indicate the classification at a second hierarchical level, the classification indicated at the second hierarchical level being a sub-classification of the classification indicated at the first hierarchical level.

11. A transmitter station comprising the apparatus of claim 10.

12. A processing apparatus for processing information transmissions received from a transmitting station, the transmissions being of a type where there is provided in at least one of said transmissions classification data formatted to comprise at least two portions each serving to indicate a classification of the associated information transmission content, wherein one of the at least two portions serves to indicate the classification at a first hierarchical level and another one of the at least two portions serves to indicated the classification at a second hierarchical level, the classification indicated at the second hierarchical level being a sub-classification of the classification indicated at the first hierarchical level, said apparatus comprising:
first analysing means for analysing said classification data to determine whether the one of the at least two portions that serves to indicate a classification at the first hierarchical level indicates a classification that corresponds to a classification previously deemed to be of interest, and
second analysing means for analysing said classification data in the event said first hierarchical level classification does so correspond, said second analysing means serving to determine whether the another one of the at least two portions serves to indicate a classification at the second hierarchical level that corresponds to a classification previously deemed to be of interest; and
means for optionally further processing said received information transmissions in the event said first and second level hierarchical level classifications correspond to those classifications deemed to be of interest by a user.

13. A receiving station comprising the apparatus of claim 12.

14. A system comprising the apparatus of claim 10.

15. A system comprising the transmitter station of claim 11.

16. A system comprising the processing apparatus of claim 12.

17. A system comprising the receiving station of claim 13.
